(19) United States
(12) Patent Application Publication
(10) Pub. No.: US 2021/0073176 A1
(43) Pub. Date: Mar. 11, 2021

(54) METHOD, DEVICE, AND COMPUTER PROGRAM PRODUCT FOR MANAGING INDEX OF STORAGE SYSTEM

(71) Applicant: EMC IP Holding Company LLC, Hopkinton, MA (US)

(72) Inventors: Willey Yongwei Lu, Kunshan (CN); Wesley Sun, Shanghai (CN)

(21) Appl. No.: 16/831,324

(22) Filed: Mar. 26, 2020

(30) Foreign Application Priority Data
Sep. 11, 2019 (CN) 201910858772.1

(51) Int. Cl. G06F 16/13

(52) U.S. Cl. CPC G06F 16/13

(57) ABSTRACT

The present disclosure relates to managing an index of a storage system. For instance, update requests are divided into groups of update requests, the update requests being used to update data items in the storage system respectively. Regarding a target update request in a group of update requests among the groups of update requests, a target leaf node in the index is determined, the target leaf node comprising a target data item that is to be updated according to the target update request. The target leaf node is updated based on the target update request. In response to determining all to-be-updated data items in the target leaf node have been updated, the updated target leaf node is added to a write queue of the storage system. Accordingly, the index of the storage system is accessible with higher efficiency, and further the overall performance of the storage system may be improved.

### RELATED APPLICATION

The present application claims the benefit of priority to Chinese Patent Application No. 201910858772.1, filed on Sep. 11, 2019, which application is hereby incorporated into the present application by reference herein in its entirety.

### FIELD

Various implementations of the present disclosure relate to the management of storage systems, and more specifically, to a method, device and computer program product for managing an index of a storage system.

### BACKGROUND

With the development of data storage technology, various data storage devices now provide users with increasingly large data storage capacities, and their data access speed is also greatly accelerated. As the data storage capacity increases, users put forward higher demands on the response time of storage systems. So far technical solutions for building an index for data stored in a storage system have been developed to accelerate the data access speed. However, the index of the storage system needs to be updated frequently during the operation of the storage system. This causes alot of time overhead and resource overhead and may further affect the response speed of the storage system. At this point, it has become a research focus regarding how to manage the index of the storage system more effectively and further improve the performance of the storage system.

### SUMMARY

Therefore, it is desirable to develop and implement a technical solution for managing an index of a storage system more effectively. It is desired that the technical solution can be compatible with an existing storage system and manage a storage system more effectively by reconstructing configurations of the existing application system.

According to a first aspect of the present disclosure, there is provided a method for managing an index of a storage system. In the method, a plurality of update requests are divided into a plurality of groups of update requests, the plurality of update requests being used to update a plurality of data items in the storage system, respectively. Regarding a target update request in a group of update requests among the plurality of groups of update requests, a target leaf node in the index is determined, the target leaf node comprising a target data item to be updated according to the target update request. The target leaf node is updated based on the target update request. In response to determining all to-be-updated data items in the target leaf node have been updated, the updated target leaf node is added to a write queue of the storage system.

According to a second aspect of the present disclosure, there is provided a device, comprising: at least one processor; a volatile memory; and a memory coupled to the at least one processor, the memory having instructions stored thereon, the instructions, when executed by the at least one processor, causing the device to perform acts. The acts include: dividing a plurality of update requests into a plurality of groups of update requests, the plurality of update requests being used to update a plurality of data items in the storage system, respectively; regarding a target update request in a group of update requests among the plurality of groups of update requests, determining a target leaf node in the index, the target leaf node comprising a target data item that is to be updated according to the target update request; updating the target leaf node based on the target update request; and in response to determining all to-be-updated data items in the target leaf node have been updated, adding the updated target leaf node to a write queue of the storage system.

According to a third aspect of the present disclosure, there is provided a computer program product. The computer program product is tangibly stored on a non-transient computer readable medium and comprises machine executable instructions which are used to implement a method according to the first aspect of the present disclosure.

### BRIEF DESCRIPTION OF THE DRAWINGS

Through the more detailed description in the accompanying drawings, features, advantages and other aspects of the implementations, the present disclosure will become more apparent. Several implementations of the present disclosure are illustrated schematically and are not intended to limit the present embodiments. In the drawings:

FIG. 1 schematically shows a block diagram of a storage system in which a method of the present disclosure may be implemented;

FIG. 2 schematically shows a block diagram of an index of a storage system in which a method of the present disclosure may be implemented;

FIG. 3 schematically shows a block diagram for managing an index of a storage system according to one implementation of the present disclosure;

FIG. 4 schematically shows a flowchart of a method for managing an index of a storage system according to one implementation of the present disclosure;

FIG. 5 schematically shows a block diagram for processing an update request according to one implementation of the present disclosure;

FIG. 6 schematically shows a block diagram for managing a further update request according to one implementation of the present disclosure;

FIG. 7A schematically shows a block diagram of a part of nodes associated with an update request in the index of the storage system according to one implementation of the present disclosure;

FIG. 7B schematically shows a block diagram of a leaf node before being updated according to one implementation of the present disclosure;

FIG. 7C schematically shows a block diagram of a leaf node after being updated according to one implementation of the present disclosure;

FIG. 8A schematically shows a block diagram for determining a shared path between two groups of update requests according to one implementation of the present disclosure;

FIG. 8B schematically shows a block diagram for updating a plurality of data items in the index of the storage system by a plurality of co-routines according to one implementation of the present disclosure; and

FIG. 9 schematically shows a block diagram of a device for managing an index of a storage system according to example implementations of the present disclosure.

### DETAILED DESCRIPTION OF IMPLEMENTATIONS

The preferred implementations of the present disclosure will be described in more detail with reference to the drawings. Although the drawings illustrate the preferred implementations of the present disclosure, it should be appreciated that the present disclosure can be implemented in various manners and should not be limited to the implementations explained herein. On the contrary, the implementations are provided to make the present disclosure more thorough and complete and to fully convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The terms “one example implementation” and “one implementation” are to be read as “at least one example implementation.” The term “a further implementation” is to be read as “at least a further implementation.” The terms “first”, “second” and so on can refer to same or different objects. The following text also can comprise other explicit and implicit definitions.

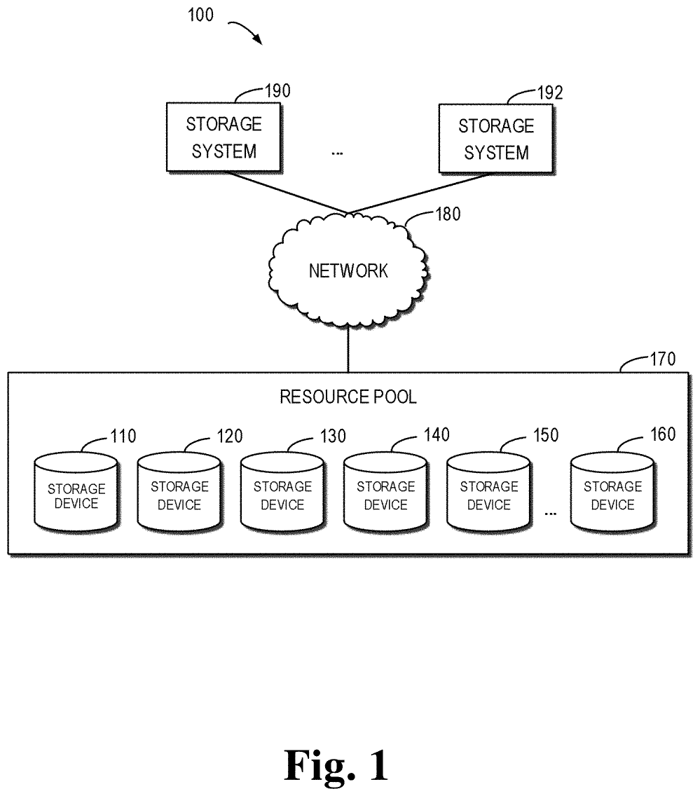

A variety of storage systems have been developed. Specifically, FIG. 1 schematically shows a block diagram 100 of a storage system in which a method of the present disclosure may be implemented. As depicted, a resource pool 170 may be provided, and the resource pool 170 may comprise a plurality of storage devices 110, 120, 130, 140, 150, . . . , 160. Although illustrated here are independent physical storage devices 110, 120, 130, 140, 150, . . . , 160, the storage devices may further be virtual storage devices according to example implementations of the present disclosure. One or more storage systems may be provided based on the resource pool 170. For example, storage systems 190 and 192 may access storage space in storage devices in the resource pool 170 via a network 180, so as to provide data access services to users.

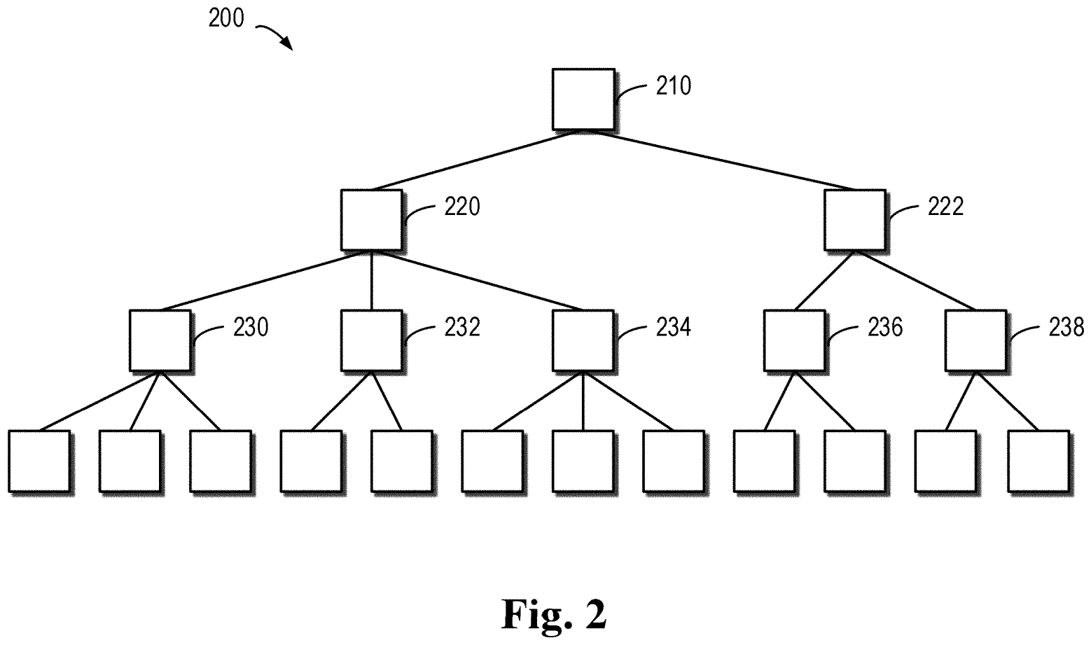

As the storage space in a storage system expands, an index needs to be built for data objects in the storage system, so as to access data objects in the storage system quickly and effectively. FIG. 2 schematically shows a block diagram of an index 200 of a storage system in which a method of the present disclosure may be implemented. As depicted, the index 200 may be a tree index and may comprise a plurality of layers. For example, the index 200 may be provided as a binary tree or a multi-way tree, which may comprise four layers.

Apart from the layer (the 0^{th} layer) where a root node 210 resides, at the first layer, nodes 220 and 222 are child nodes of the root node 210. At the second layer, nodes 230, 232 and 234 may be child nodes of the node 220, and nodes 236 and 238 may be child nodes of the node 222. At the third layer, more leaf nodes may be comprised. It will be understood although FIG. 2 illustrates the index 200 comprising four layers, more or less layers may be comprised according to example implementations of the present disclosure.

Each leaf node may comprise a plurality of data items, each of which may comprise data about one data object (e.g., may comprise metadata). According to example implementations of the present disclosure, metadata may comprise many contents about the data object, e.g., may comprise one or more of an identifier, a storage address, a timestamp and an owner of the data object. The plurality of data items may be sorted in an order of keys of these data items (e.g., in increasing order). At this point, in the index 200 as shown in FIG. 2, leaf nodes are sorted in a small-to-large (left-to-right) order of keys. It will be understood a leaf node may have a key range, which represents a range of keys of data items comprised in the leaf node. For example, suppose keys of data items comprised in a leaf node are key1 and key2, respectively, and a key of a data item of the next neighboring leaf node is key3, then a key range of the leaf node may be represented as [key1, key3).

Similarly, a non-leaf node of the index 200 may also have a corresponding key range, which may represent a range of keys of data items comprised in all leaf nodes whose root is the non-leaf node. Suppose a non-leaf node has two child nodes, and their key ranges are [key1, key3) and [key3, key4) respectively, then at this point a key range of the non-leaf node may be represented as [key1, key4).

It will be understood although FIG. 2 illustrates the index 200 in the form of a multi-way tree, the index 200 may further be provided in another form according to example implementations of the present disclosure. For example, the index 200 may be stored using a binary tree, a multi-way tree, a B+ tree, etc. It will be understood although FIG. 2 illustrates the index 200 as comprising four layers, the index 200 may further comprise more or less layers according to example implementations of the present disclosure.

According to example implementations of the present disclosure, in a storage system, an index in the form of a B+ tree may be used to persist metadata. B+ tree dump (merging a memory table to the persistent B+ tree) is a critical procedure in the storage system, which will directly affect the maximum performance of the storage system. In the dump procedure, first all essential nodes in the index need to be loaded to a memory, and contents in nodes need to be updated. Subsequently the B+ tree may be traversed to find dirty nodes and flush them to storage devices of the storage system. This procedure usually costs alot of time and consumes large memory space and many system I/O and computing resources.

As the number of data objects stored in the storage system increases, the index of the storage system gets increasingly complex. At this point, it will take huge resources (e.g., storage resources, computing resources and time resources) of the storage system to manage the index of the storage system. For example, resources of memories in the storage system might be limited, and not all of the indexes can be loaded to memories at a time. While managing the index, a memory swap is a must so as to load necessary data to memories. Furthermore, since contents of parent nodes in the index rely on contents of child nodes, when a parent node comprises a plurality of child nodes, the content of the parent node might be changed several times.

There has been proposed a technical solution for processing different portions in an index based on a plurality of co-routines. In this technical solution, a plurality of update requests for updating a plurality of data items in the index may be assigned to a plurality of co-routines. At this point, a specialized algorithm needs to be built so as to coordinate operations of the plurality of co-routines. However, existing coordination mechanisms will cause alot of time overhead and further make the operation of the storage system inefficient.

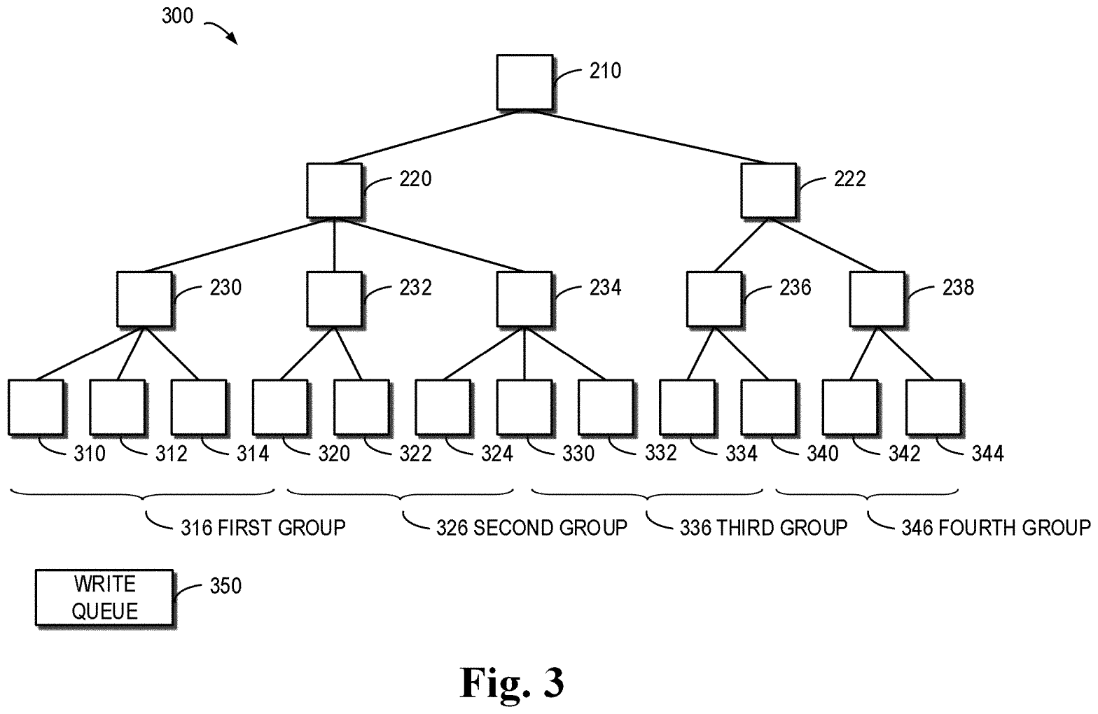

To solve the above drawbacks, implementations of the present disclosure provide a method, device and computer program product for managing an index of a storage system. A detailed description is presented below to specific implementations of the present disclosure with reference to FIG. 3. This figure schematically shows a block diagram 300 for managing an index in a storage system according to one implementation of the present disclosure. According to example implementations of the present disclosure, a plurality of update requests may be divided into a plurality of groups of update requests. For example, a first group 316 of update requests, a second group 326 of update requests, a third group 336 of update requests and a fourth group 346 of update requests may be obtained. Each group of update requests may comprise a plurality of update requests, and they are used to update a plurality of data items in the storage system respectively. Here a plurality of groups of update requests may be processed in parallel by means of a plurality of co-routines. In this way, the processing efficiency of the storage system may be improved.

Further, according to example implementations of the present disclosure, there is proposed the concept of a write queue 350. A leaf node may comprise data items about a plurality of data objects. After a target leaf node is updated based on a target update request, if it is determined all to-be-updated data items in the target leaf node have been updated, then the updated target leaf node may be added to a write queue of the storage system. By means of example implementations of the present disclosure, while adding a node to the write queue, since consideration is given to whether various nodes have dependencies among them or not, nodes in the write queue 350 may be processed one after another in a front-to-back order. Accordingly, it may be that guaranteed data items in an updated node will not be affected by a subsequent update request and further a node may be prevented from being written repetitively.

By means of example implementations of the present disclosure, various nodes in the index may be updated in time, so that a writable node may be marked as early as possible and stored to a storage device in the storage system. In this way, the dump performance of the index may be improved, the memory resource consumption in the dump procedure may be reduced, and further overheads of computing resources and IO resources may be cut down.

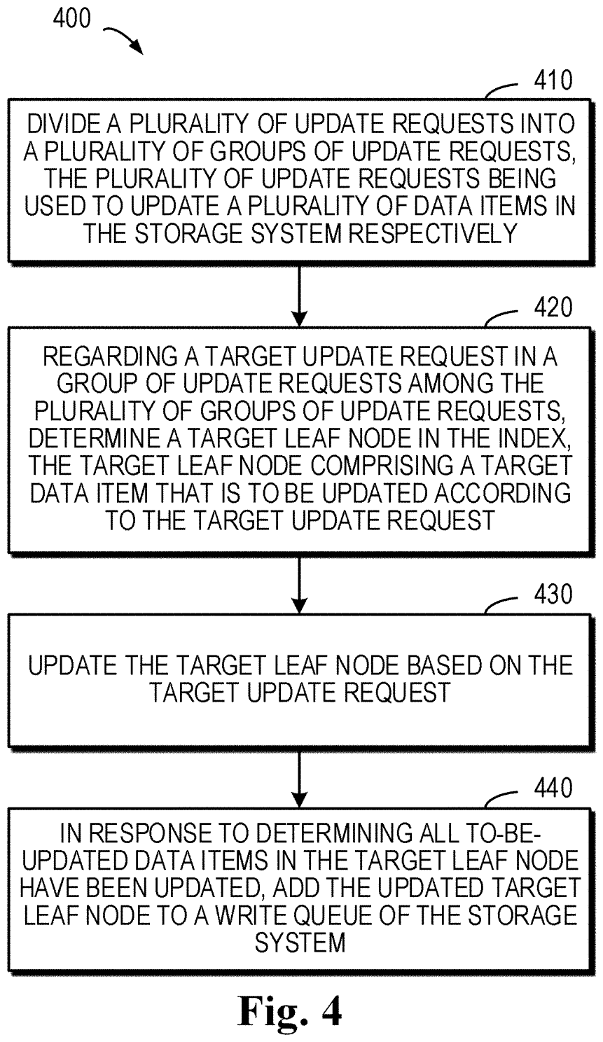

More details about implementations of the present disclosure will be described in detail with reference to FIG. 4. This figure schematically shows a flowchart of a method 400 for managing an index of a storage system according to one implementation of the present disclosure. As depicted, at block 410, a plurality of update requests are divided into a plurality of groups of update requests, here the plurality of update requests are used to update a plurality of data items in the storage system respectively.

As shown in FIG. 3, the first group 316 of update requests may involve updating data items in leaf nodes 310, 312, 314 and 320, the second group 326 of update requests may involve updating data items in leaf nodes 320, 322, 324 and 330, the third group 336 of update requests may involve updating data items in leaf nodes 330, 332, 334 and 340, and the fourth group 346 of update requests may involve updating data items in leaf nodes 340, 342 and 344. Here these groups of update requests may be processed in parallel by using a plurality of co-routines, so that the processing efficiency of the storage system may be improved. It will be understood since one leaf node may comprise a plurality of data items, leaf nodes accessed by the plurality of groups might have an intersection. For example, both the first group 316 of update requests and the second group 326 of update requests will access the leaf node 320.

According to example implementations of the present disclosure, the plurality of update requests are sorted in an order of keys of a plurality of data items that are to be updated according to the plurality of update requests. With example implementations of the present disclosure, by sorting the plurality of update requests, they may be processed in order (e.g., in a small-to-large order of keys) when processing them. It will be understood since various leaf nodes in the index 200 are arranged in an order of keys of data items, when processing each of the plurality of update requests one by one, various leaf nodes in the index 200 may be traversed in a left-to-right order. Further, the efficiency of retrieving a leaf node corresponding to an update request in the index 200 may be improved, and also the processing performance of the storage system may be increased.

At block 420, regarding a target update request in one of the plurality of groups of update requests, a target leaf node in the index is determined, and the target leaf node comprises a target data item to be updated according to the target update request. Here processing may be performed on each of the plurality of groups of update requests, for example, each update request in a group of update requests may be traversed one by one. First of all, a first update request (i.e., target update request) in the first group 316 of update requests may be processed. Here a target data item to be updated according to the target update request is determined based on a key in the target update request.

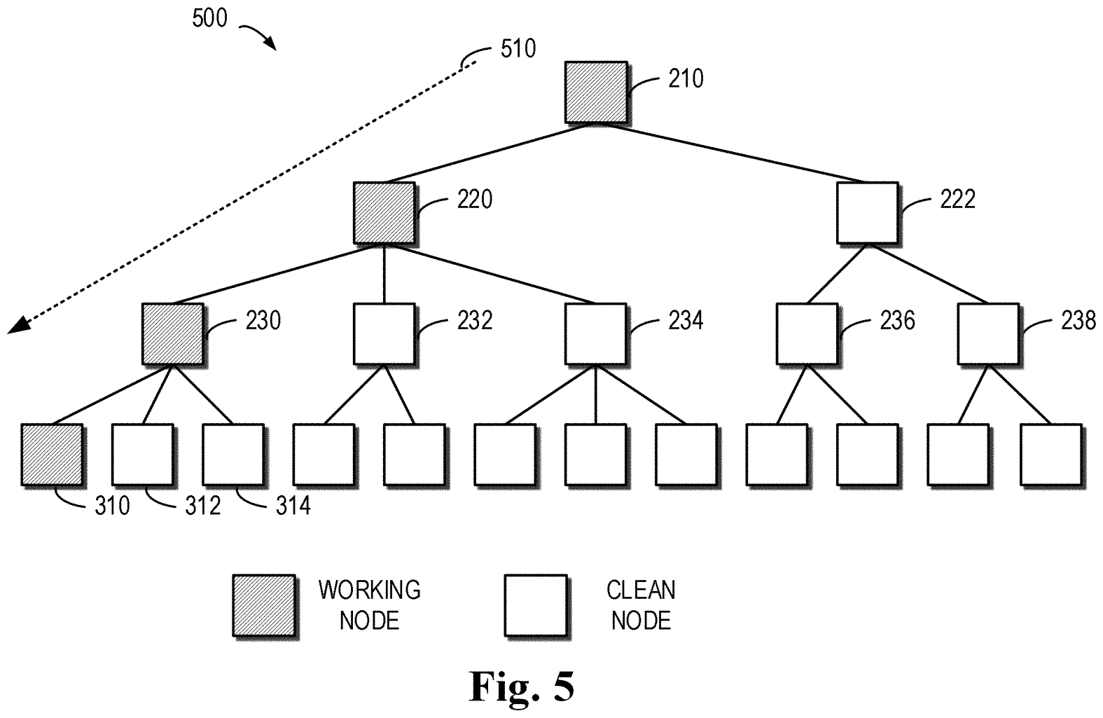

Specifically, a key of the target data item may be determined first, and then a leaf node corresponding to the key may be looked up in the index 200. In other words, a leaf node which needs to be updated needs to be found in the index 200. Since various nodes (including non-leaf nodes and leaf nodes) in the index 200 have their respective key ranges, the target leaf node may be determined by comparing the key of the target data item with key ranges of various nodes. More details on how to process an update request will be described with reference to FIG. 5. This figure schematically shows a block diagram 500 for updating an update request according to one implementation of the present disclosure. If it is determined the target data item to be updated according to the target update request is the left-most leaf node 310 in the index 200, then at this point the leaf node 310 may be determined as a target leaf node.

Returning to FIG. 4, at block 430, the target leaf node may be updated based on the target update request. It will be understood since the leaf node 310 may comprise a plurality of data items, after the target leaf node is determined, a location in the target leaf node which corresponds to the target update request needs to be determined further. A location of the target data item may be determined based on the key of the target data item and a key range of the target leaf node.

According to example implementations of the present disclosure, the update request may comprise at least one of an insert request and a delete request. It will be understood the index 200 of the storage system may be managed by the insert and delete pattern. If a new data object is inserted into the storage system, a data item corresponding to the new data object may be inserted into the index. If a data object is deleted from the storage system, then a data item corresponding to the to-be-deleted data object may be deleted from the index. If the content of an existing data object in the storage system is changed, then a data item corresponding to the existing data object may be deleted from the index, and a data item corresponding to the changed data object may be inserted into the index.

With reference to FIG. 5, description is presented below to a specific way of executing an insert request. According to example implementations of the present disclosure, the type of the update request may be determined first. If it is determined the update request is an insert request, then the target data item is inserted to a location in the target leaf node in the index 200 which corresponds to a key of the target data item. As shown in FIG. 5, where it is determined the leaf node 310 is the target leaf node, the key of the target data item may be compared with a key of each data item in the leaf node 310, and a proper insert location may be selected.

Suppose the leaf node 310 comprises a plurality of data items: data item A with a key of 0x9A, data item B with a key of 0x9C, and the target data item with a key of 0x9B. At this point, the target data item may be inserted between data item A and data item B. In this way, the target leaf node may be updated. It will be understood the update merely involves updating based on the first update request in a group of update requests. The group of update requests may further comprise other update requests for updating other data items in the target leaf node, at which point other update requests need to be processed one after another.

According to example implementations of the present disclosure, each update request in the group of update requests may be processed in order. Specifically, an update request after the target update request in the group of update requests may be identified as a target update request. Similarly, the second update request, the third update request, . . . , and other update requests in the group of update requests may be processed in order, till all update requests in the group are processed.

It will be understood when processing a subsequent update request, a target data item involved in the subsequent update request may reside in the above target leaf node (i.e., leaf node 310). At this point, an insert request may be executed in a similar way to the above. Returning to FIG. 4, at block 440, if it is determined all to-be-updated data items in the target leaf node have been updated, then the updated target leaf node may be added to the write queue of the storage system. Continuing the above example, if all data items that are supposed to be inserted into the leaf node 310 have been inserted into the leaf node 310, then the update of the leaf node 310 is completed and thus may be added to the write queue 350, waiting for data items in the leaf node 310 to be written to a storage device in the storage system.

According to example implementations of the present disclosure, there is proposed a concept of a working path. As shown in FIG. 5, a slash block shows a working node (i.e., to-be-updated node), and a blank block shows a clean node (i.e., node that does not need to be updated). When the leaf node 310 is a current leaf node, a path 510 from the leaf node 310 to the root node is a working path (comprising the leaf node 310, the non-leaf nodes 230 and 220, as well as the root node 210). Description has been presented to the circumstance in which a subsequent update request and a previous update request involve the same leaf node 310. Further, the group of update requests may involve different leaf nodes.

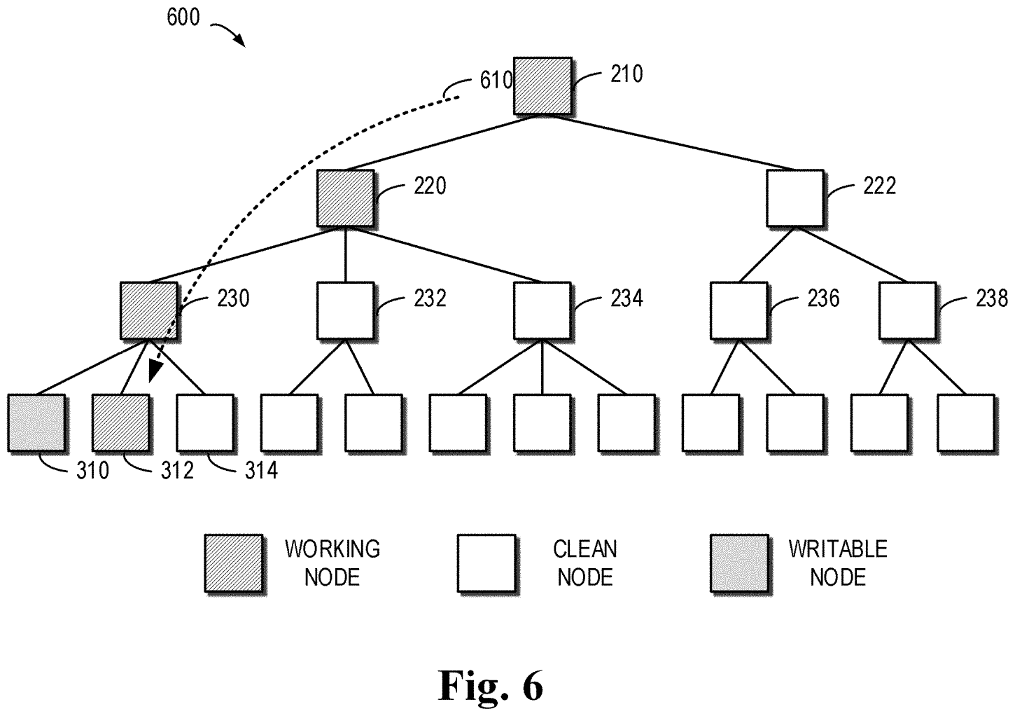

According to example implementations of the present disclosure, a target data item involved in a subsequent update request may reside in another leaf node after the above target leaf node (i.e., leaf node 310). A detailed description is presented below with reference to FIG. 6, which schematically shows a block diagram 600 for processing a further update request according to one implementation of the present disclosure. As shown in FIG. 6, after all update requests associated with the leaf node 310 in the group of update requests are processed, the leaf node 310 may be marked as a writable node. The writable node represents a node which may be added to a write list, and in other words, the node may be stored to a storage device in the storage system.

Subsequently, the current update request is moved to the next update request in the group of update requests. Suppose this update request involves updating a data item in the leaf node 312, then at this point the leaf node 312 will be marked as a target leaf node. Then, the current update request and subsequent update requests may be processed in a way described above. The working path is then as shown by a reference numeral 610.

According to example implementations of the present disclosure, it may be further judged based on the working path which nodes may be added to the write queue. Specifically, a group of nodes located on the left of the working path in the tree structure may be determined. Since the key range related to the determined group of nodes is smaller than the key range of nodes in the working path, the determined group of nodes may be marked as writable nodes and subsequently added to the write queue.

Although FIG. 6 illustrates the circumstance in which the working path 610 comprises one leaf node 310 on its left, as more and more update requests are processed, the working path may gradually move to the right of the tree index, at which point more and more nodes will be marked as writable nodes. For example, suppose the working path comprises the leaf node 314, the non-leaf nodes 230 and 220, as well as the root node 210, then at this point both the leaf nodes 310 and 312 may be marked as writable nodes. With example implementations of the present disclosure, a node which may be stored to a storage device in the storage system may be determined more quickly and more effectively.

It will be understood although how an update request is processed has been described by taking an insert request as an example, the update request may further be a delete request. At this point, a data item may be deleted from the target leaf node similarly. Continuing the above example, suppose a key of a data item to be deleted is 0x9C, then a data item corresponding to the key may be deleted from the leaf node 310. It will be understood here the group of update requests may only comprise insert requests, only comprise delete requests, or comprise both insert requests and delete requests. The insert request and delete request may be processed separately as described above.

According to example implementations of the present disclosure, nodes in the write queue may be stored to the memory of the storage system. It will be understood since various nodes in the write queue are sorted in an order of updated dependencies, as long as each node is stored in an order of the write queue, it may be guaranteed a node with a dependency with a previous node is finally written, and further repetitive writes of the same node may be avoided.

It will be understood a value of a data item at a header of a leaf node will affect a key range of the leaf node, and might further cause the key range of the leaf node to change when an update request changes the data item at the header of the leaf node. At this point, the key range of the leaf node (and one or more parent nodes of the leaf node) needs to be modified based on the updated key.

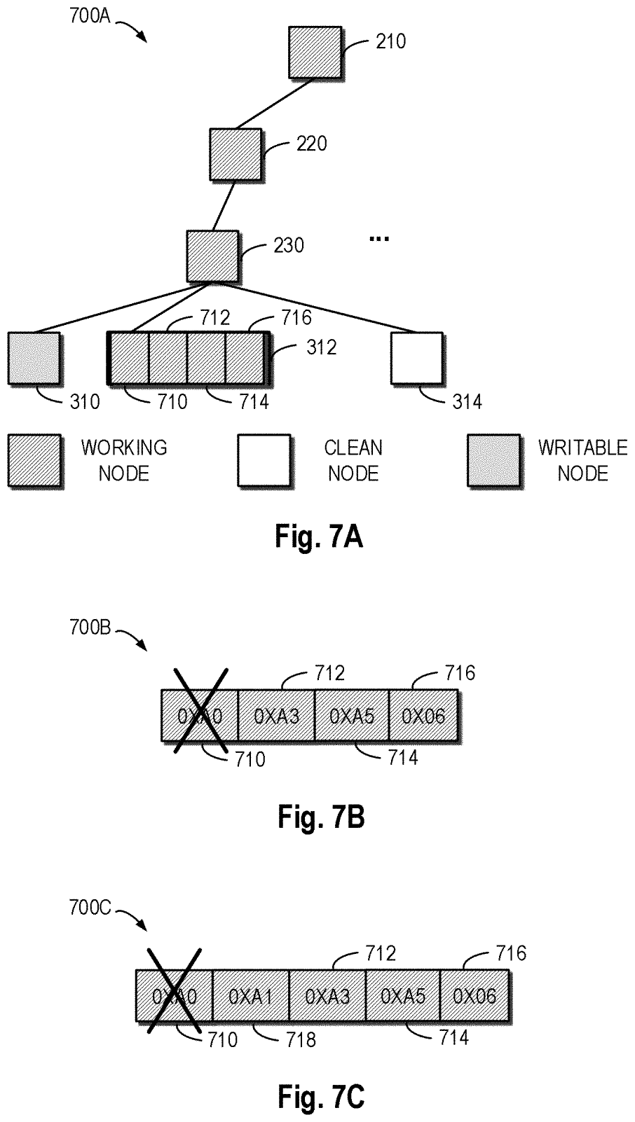

According to example implementations of the present disclosure, if it is determined the key range of the target leaf node is different from the updated key range of the updated target leaf node, then the target leaf node may be marked as a shadow node. Afterwards, key ranges of the shadow node and its parent node may be updated in subsequent processing. Specifically, a key range of a further node in the working path may be updated based on the marked target leaf node. A detailed description is presented below with reference to FIGS. 7A to 7C.

FIG. 7A schematically shows a block diagram 700A of part of nodes associated with an update request in the index of the storage system according to one implementation of the present disclosure. For the purpose of simplicity, FIG. 7A merely illustrates part of nodes associated with an update request. As depicted, lower layers of the root node 210 may comprise the non-leaf node 220 at the first layer, the non-leaf node 230 at the second layer, as well as the leaf nodes 310, 312 and 314 at the third layer. Suppose the leaf node 312 comprises data items 710, 712, 714 and 716. Suppose at this point a group of update requests comprise: deleting a data item with a key of 0xA0, and then inserting a data item with a key of 0xA1. Description is presented below on how to execute the group of update requests with reference to FIGS. 7B and 7C.

FIG. 7B schematically shows a block diagram 700B of a leaf node before being updated according to one implementation of the present disclosure. At this point, the leaf node 312 comprises the data item 710 (with a key of 0xA0), the data item 712 (with a key of 0xA3), the data item 714 (with a key of 0xA5), as well as the data item 716 (with a key of 0xA6). FIG. 7C schematically shows a block diagram 700C of a leaf node after being updated according to one implementation of the present disclosure. As is clear based on a key 0xA1 of a to-be-inserted data item and keys of existing data items in the leaf node 312, a data item 718 may be inserted between the data item 710 and the data item 712.

Since deleting a data item from the leaf node 312 will change the key range of the leaf node 312, the leaf node 312 may be marked as a shadow node, and later its key range may be updated using a key of the data item 718. It will be understood that since a range of parent nodes of the leaf node may be affected by the key range of the leaf node, key ranges of one or more upper-layer parent nodes may be updated using the key range of the leaf node. According to example implementations of the present disclosure, regarding a further node in the working path, if it is determined its key range has been updated, then the further node may be added to the write queue 350.

Description has been given on how to process one of the plurality of update requests with reference to the figures. According to example implementations of the present disclosure, the plurality of update requests may be processed in parallel. For example, a plurality of co-routines may be specified so as to process the plurality of update requests, respectively. At this point, one group of update requests may be processed by one co-routine in a way described above. With example implementations of the present disclosure, the plurality of co-routines may process the plurality of update requests in parallel, which greatly improves the performance of updating the index in the storage system.

Specifically, suppose 10000 data items in the index need to be updated. If 16 co-routines are used to process update requests, then each of them only needs to process 10000/16=625 update requests. With example implementations of the present disclosure, the capacity of parallel processing of the storage system may be increased significantly.

Specifically, two groups of update requests might contain a shared path. In other words, nodes on the shared path may be affected by both of the two groups of update requests. At this point, regarding a given node on the shared path, only after update requests associated with the node in both groups of update requests are executed, the updating of the node is completed. Subsequently, the node may be marked as a writable node and added to the write queue.

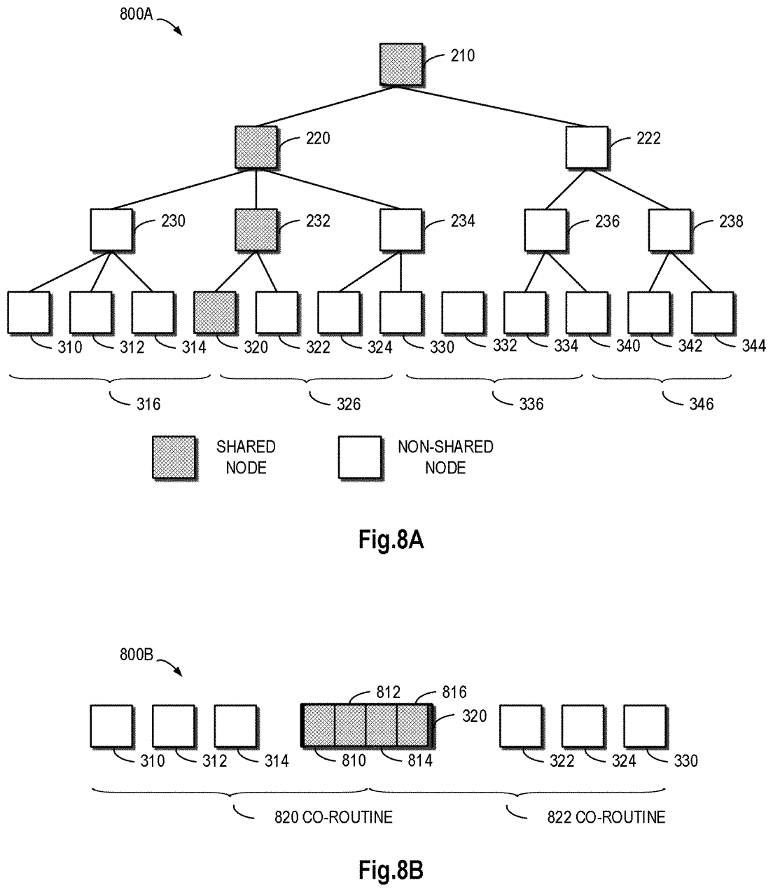

According to example implementations of the present disclosure, a shared path between the group of update requests and a further group of update requests may be determined based on a key of a first update request in the further group of update requests after the group of update requests. More details on how to determine the shared path will be described with reference to FIG. 8A below. This figure schematically shows a block diagram 800A for determining a shared path between two groups of update requests according to one implementation of the present disclosure.

As shown in FIG. 8A, suppose the first group 316 involves updating data items in the leaf nodes 310, 312, 314 and 320, and the second group 326 involves updating data items in the leaf nodes 320, 322, 324 and 330. At this point, considering the first update request in the second group 326 of update requests involves updating a data item in the leaf node 320, it may be determined that the leaf node 320 is a shared node. Subsequently, shared nodes on the shared path may be determined based on a path between the leaf node 320 and the root node 210.

According to example implementations of the present disclosure, if a data item of a leaf node on the shared path has been updated, then the leaf node is added to the write queue. As shown in FIG. 8A, shared nodes between the first group 316 of update requests and the second group 326 of update requests may comprise the leaf node 320 and the non-leaf node 232. At this point, only after all update requests associated with the leaf node 320 in both the first group 316 and the second group 326 are executed, the leaf node 320 may be added to the write queue.

According to example implementations of the present disclosure, regarding a further node other than the leaf node on the shared path, the further node is updated in response to determining a sub-tree of the further node has been updated. Subsequently, the updated further node may be added to the write queue. Furthermore, only after all child nodes of the non-leaf node 232 are updated and the non-leaf node 232 itself is updated, the non-leaf node 320 may be added to the write queue. Shared nodes between other groups of update requests may be determined similarly. For example, shared nodes between the first group 316 of update requests, the second group 326 of update requests and the third group of update requests may include the non-leaf node 220.

Description is presented below on how to execute a plurality of update requests by using a plurality of co-routines in parallel with reference to FIG. 8B. This figure schematically shows a block diagram 800B of updating a plurality of data items in the index by a plurality of co-routines according to one implementation of the present disclosure. Suppose the first group 316 of update requests involve updating data items in the leaf nodes 310, 312 and 314 and updating data items 810 and 812 in the leaf node 320. At this point, the first group 316 of update requests may be executed using a co-routine 820. Suppose the second group 326 of update requests involve updating data items 814 and 816 in the leaf node 320 and further involve updating data items in the leaf nodes 322, 324 and 330. At this point, the second group 326 of update requests may be executed using a co-routine 822. With example implementations of the present disclosure, a plurality of co-routines may perform the above method in parallel, so as to process a plurality of update requests with higher efficiency.

While examples of the method according to the present disclosure have been described in detail with reference to FIGS. 2 to 8B, description is presented below to the implementation of a corresponding apparatus. According to example implementations of the present disclosure, provided is an apparatus for managing an index of a storage system. The apparatus comprises: a dividing module configured to divide a plurality of update requests into a plurality of groups of update requests, the plurality of update requests being used to update a plurality of data items in the storage system respectively; a determining module configured to, regarding a target update request in a group of update requests among the plurality of groups of update requests, determine a target leaf node in the index, the target leaf node comprising a target data item that is to be updated according to the target update request; an updating module configured to update the target leaf node based on the target update request; and an adding module configured to, in response to determining all to-be-updated data items in the target leaf node have been updated, add the updated target leaf node to a write queue of the storage system.

According to example implementations of the present disclosure, there is further comprised: a storage module configured to store a node in the write queue to a memory of the storage system.

According to example implementations of the present disclosure, the plurality of update requests are sorted in an order of keys of a plurality of data items that are to be updated according to the plurality of update requests.

According to example implementations of the present disclosure, the apparatus further comprises: an identifying module configured to identify an update request after the target update request in the group of update requests as a target update request.

According to example implementations of the present disclosure, the index comprises a tree structure, and the apparatus further comprises: a path determining module configured to determine a working path of the target leaf node in the index based on the target leaf node and a root node of the tree structure; a node determining module configured to determine a group of nodes on the left of the working path in the tree structure; and the adding module being further configured to add the determined group of nodes to the write queue.

According to example implementations of the present disclosure, the update request comprises at least one of an insert request and a delete request, and the updating module is further configured to: determine the type of the update request; and update target the leaf node based on the determined type.

According to example implementations of the present disclosure, the updating module further comprises: a location determining module configured to determine a location of the target data item based on a key of the target data item and a key range of the target leaf node; and update the target leaf node based on the determined location.

According to example implementations of the present disclosure, the updating module further comprises: a marking module configured to mark the target leaf node in response to determining the key range of the target leaf node is different from an updated key range of the updated target leaf node; and a range updating module configured to update a key range of a further node in the working path based on the marked target leaf node.

According to example implementations of the present disclosure, the adding module is further configured to: regarding a further node in the working path, add the further node to the write queue in response to determining a key range of the further node has been updated.

According to example implementations of the present disclosure, the apparatus further comprises: a shared path determining module configured to determine a shared path between the group of update requests and a further group of update requests based on a key of the first update request in the further group of update requests after the group of update requests; and the adding module is further configured to, in response to determining a data item in a leaf node in the shared path has been updated, add the leaf node to the write queue.

According to example implementations of the present disclosure, the updating module is further configured to: regarding a further node other than the leaf node in the shared path, update the further node in response to determining a sub-tree of the further node has been updated; and the adding module is further configured to add the updated further node to the write queue.

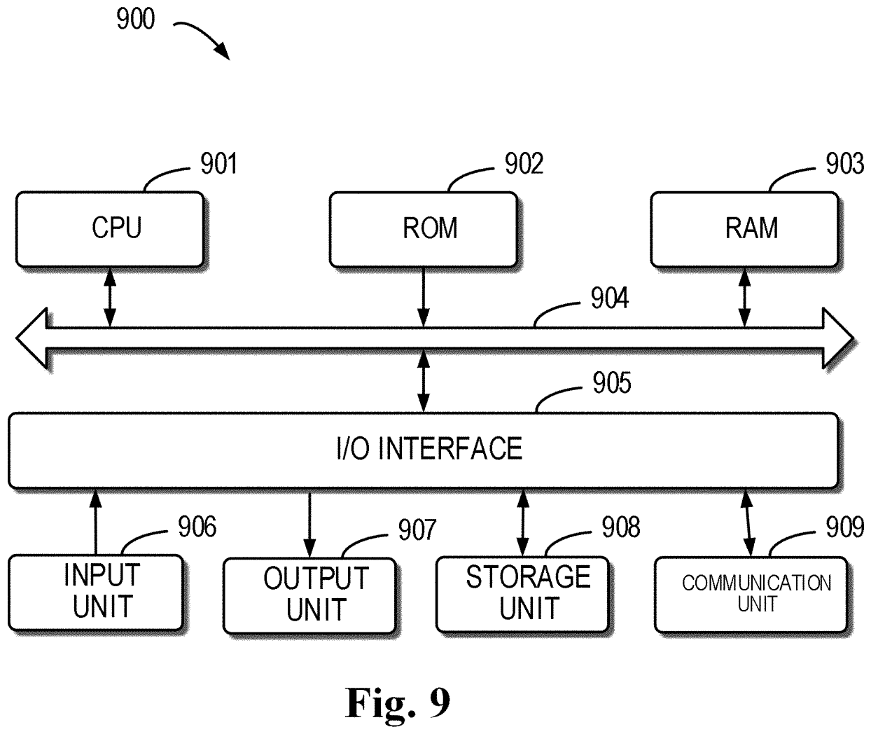

FIG. 9 schematically shows a block diagram of a device 900 for managing an index of a storage system according to example implementations of the present disclosure. As depicted, the device 900 includes a central process unit (CPU) 901, which can execute various suitable actions and processing based on the computer program instructions stored in the read-only memory (ROM) 902 or computer program instructions loaded in the random-access memory (RAM) 903 from a storage unit 908. The RAM 903 can also store all kinds of programs and data required by the operations of the device 900. CPU 901, ROM 902 and RAM 903 are connected to each other via a bus 904. The input/output (I/O) interface 905 is also connected to the bus 904.

A plurality of components in the device 900 are connected to the I/O interface 905, including: an input unit 906, such as a keyboard, mouse and the like; an output unit 907, e.g., various kinds of displays and loudspeakers etc.; a storage unit 908, such as a magnetic disk and optical disk etc.; and a communication unit 909, such as a network card, modem, wireless transceiver and the like. The communication unit 909 allows the device 900 to exchange information/data with other devices via the computer network, such as Internet, and/or various telecommunication networks.

The above described each process and treatment, such as the method 400 can also be executed by the processing unit 901. For example, in some implementations, the method 900 can be implemented as a computer software program tangibly included in the machine-readable medium, e.g., the storage unit 908. In some implementations, the computer program can be partially or fully loaded and/or mounted to the device 900 via ROM 902 and/or the communication unit 909. When the computer program is loaded to the RAM 903 and executed by the CPU 901, one or more steps of the above described method 400 can be implemented. Alternatively, in other implementations, the CPU 901 also can be configured in other suitable manners to realize the above procedure/method.

According to example implementations of the present disclosure, there is provided a device, comprising: at least one processor; a volatile memory; and a memory coupled to the at least one processor, the memory having instructions stored thereon, the instructions, when executed by the at least one processor, causing the device to perform acts for managing an index of a storage system. The acts include: dividing a plurality of update requests into a plurality of groups of update requests, the plurality of update requests being used to update a plurality of data items in the storage system respectively; regarding a target update request in a group of update requests among the plurality of groups of update requests, determining a target leaf node in the index, the target leaf node comprising a target data item that is to be updated according to the target update request; updating the target leaf node based on the target update request; and in response to determining all to-be-updated data items in the target leaf node have been updated, adding the updated target leaf node to a write queue of the storage system.

According to example implementations of the present disclosure, the acts further comprise: storing a node in the write queue to a memory of the storage system.

According to example implementations of the present disclosure, the plurality of update requests are sorted in an order of keys of a plurality of data items that are to be updated according to the plurality of update requests, the acts further comprising: identifying an update request after the target update request in the group of update requests as a target update request.

According to example implementations of the present disclosure, the index comprises a tree structure, and the device further comprises: determining a working path of the target leaf node in the index based on the target leaf node and a root node of the tree structure; determining a group of nodes on the left of the working path in the tree structure; and adding the determined group of nodes to the write queue.

According to example implementations of the present disclosure, the update request comprises at least one of an insert request and a delete request, and updating the target leaf node based on the target update request comprises: determining the type of the update request; and updating the target leaf node based on the determined type.

According to example implementations of the present disclosure, the acts further comprise: determining a location of the target data item based on a key of the target data item and a key range of the target leaf node; and updating the target leaf node based on the determined location.

According to example implementations of the present disclosure, the acts further comprise: marking the target leaf node in response to determining the key range of the target leaf node is different from an updated key range of the updated target leaf node; and updating a key range of a further node in the working path based on the marked target leaf node.

According to example implementations of the present disclosure, the acts further comprise: regarding a further node in the working path, adding the further node to the write queue in response to determining a key range of the further node has been updated.

According to example implementations of the present disclosure, the acts further comprise: determining a shared path between the group of update requests and a further group of update requests based on a key of the first update request in the further group of update requests after the group of update requests; and in response to determining a data item in a leaf node in the shared path has been updated, adding the leaf node to the write queue.

According to example implementations of the present disclosure, the acts further comprise: regarding a further node other than the leaf node in the shared path, updating the further node in response to determining a sub-tree of the further node has been updated; and adding the updated further node to the write queue.

According to example implementations of the present disclosure, there is provided a computer program product. The computer program product is tangibly stored on a non-transient computer readable medium and comprises machine executable instructions which are used to implement the method according to the present disclosure.

According to example implementations of the present disclosure, there is provided a computer readable medium. The computer readable medium has machine executable instructions stored thereon, the machine executable instructions, when executed by at least one processor, causing the at least one processor to implement the method according to the present disclosure.

The present disclosure can be a method, device, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, an electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can include copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages consist of object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some implementations, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow charts and/or block diagrams of method, apparatus (system) and computer program products according to implementations of the present disclosure. It should be understood that each block of the flow charts and/or block diagrams and the combination of various blocks in the flow charts and/or block diagrams can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions contains an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow charts and block diagrams in the drawings illustrate system architecture, functions and operations that may be implemented by system, method and computer program products according to a plurality of implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order depending on the functions involved. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various implementations of the present disclosure have been described above and the above description is only exemplary rather than exhaustive and is not limited to the implementations of the present disclosure. Many modifications and alterations, without deviating from the scope and spirit of the explained various implementations, are obvious for those skilled in the art. The selection of terms in the text aims to best explain principles and actual applications of each implementation and technical improvements made in the market by each implementation, or enable others of ordinary skill in the art to understand implementations of the present disclosure.

I/We claim:

1. A method for managing an index of a storage system, the method comprising:
dividing, by a system comprising a processor, a plurality of update requests into a plurality of groups of update requests, the plurality of update requests being used to update a plurality of data items in the storage system respectively;
regarding a target update request in a group of update requests among the plurality of groups of update requests, determining a target leaf node in the index, the target leaf node comprising a target data item that is to be updated according to the target update request;
updating the target leaf node based on the target update request, resulting in an updated target leaf node; and
in response to determining all to-be-updated data items in the target leaf node have been updated, adding the updated target leaf node to a write queue of the storage system.

2. The method of claim 1, further comprising: storing a node in the write queue to a memory of the storage system.

3. The method of claim 1, wherein the plurality of update requests are sorted in an order of keys of a plurality of to-be-updated data items that are to be updated according to the plurality of update requests, the method further comprising:
identifying an update request after the target update request in the group of update requests as a target update request.

4. The method of claim 3, wherein the index comprises a tree structure, the method further comprising:
determining a working path of the target leaf node in the index based on the target leaf node and a root node of the tree structure;
determining a group of nodes on a left side of the working path in the tree structure, resulting in a determined group of nodes; and
adding the determined group of nodes to the write queue.

5. The method of claim 1, wherein the update request comprises at least one of an insert request and a delete request, and wherein the updating the target leaf node based on the target update request comprises:
determining a type of the update request; and
updating the target leaf node based on the type.

6. The method of claim 5, further comprising:
determining a location of the target data item based on a key of the target data item and a first key range of the target leaf node; and
updating the target leaf node based on the location.

7. The method of claim 6, further comprising:
marking the target leaf node in response to determining the first key range of the target leaf node is different from an updated key range of the updated target leaf node, the marking resulting in a marked target leaf node; and
updating a second key range of a further node in the working path based on the marked target leaf node.

8. The method of claim 7, further comprising: regarding the further node in the working path,
adding the further node to the write queue in response to determining the second key range of the further node has been updated.

9. The method of claim 3, further comprising:
determining a shared path between the group of update requests and a further group of update requests based on a key of the first update request in the further group of update requests after the group of update requests; and
in response to determining a data item in a leaf node in the shared path has been updated, adding the leaf node to the write queue.

10. The method of claim 9, further comprising: regarding a further node other than the leaf node in the shared path,
updating the further node in response to determining a sub-tree of the further node has been updated, resulting in an updated further node; and
adding the updated further node to the write queue.

11. A device, the device comprising:
at least one processor;
a volatile memory; and
a memory coupled to the at least one processor and having instructions stored thereon, the instructions, when executed by the at least one processor, causing the device to perform acts for managing an index of a storage system, the acts comprising:
dividing update requests into groups of update requests, the update requests respectively being used to update data items in the storage system;
regarding a target update request in a group of update requests of the groups of update requests, determining a target leaf node in the index, the target leaf node comprising a target data item that is to be updated according to the target update request;
updating the target leaf node based on the target update request, resulting in an updated target leaf node; and
in response to determining all to-be-updated data items in the target leaf node have been updated, adding the updated target leaf node to a write queue of the storage system.

12. The device of claim 11, wherein the acts further comprise: storing a node in the write queue to a memory of the storage system.

13. The device of claim 11, wherein the update requests are sorted in an order of keys of ones of the data items that are to be updated according to the update requests, the acts further comprising:
identifying an update request after the target update request in the group of update requests as a target update request.

14. The device of claim 13, wherein the index comprises a tree structure, the acts further comprising:
determining a working path of the target leaf node in the index based on the target leaf node and a root node of the tree structure;
determining a group of nodes on a left part of the working path in the tree structure; and
adding the group of nodes to the write queue.

15. The device of claim 11, wherein the update request comprises at least one of an insert request and a delete request, and updating the target leaf node based on the target update request comprises:
determining a type of the update request; and
updating the target leaf node based on the type.

16. The device of claim 15, wherein the acts further comprise:
determining a location of the target data item based on a key of the target data item and a key range of the target leaf node; and
updating the target leaf node based on the location.

17. The device of claim 16, wherein the acts further comprise:
marking the target leaf node in response to determining the key range of the target leaf node is different from an updated key range of the updated target leaf node, the marking resulting in a marked target leaf node; and
updating a further key range of a further node in the working path based on the marked target leaf node.

18. The device of claim 17, wherein the acts further comprise: regarding the further node in the working path,
adding the further node to the write queue in response to determining the further key range of the further node has been updated.

19. The device of claim 13, wherein the acts further comprise:
determining a shared path between the group of update requests and a further group of update requests of the groups of update requests based on a key of the first update request in the further group of update requests after the group of update requests; and
in response to determining a data item in a leaf node in the shared path has been updated, adding the leaf node to the write queue.

20. A computer program product, tangibly stored on a non-transient computer readable medium and comprising machine executable instructions, which are used to perform operations, comprising:
dividing a plurality of update requests into a plurality of groups of update requests, the plurality of update requests being used to update a plurality of data items in the storage system respectively;
regarding a target update request in a group of update requests among the plurality of groups of update requests, determining a target leaf node in the index, the target leaf node comprising a target data item that is to be updated according to the target update request;
updating the target leaf node based on the target update request, resulting in an updated target leaf node; and
in response to determining all to-be-updated data items in the target leaf node have been updated, adding the updated target leaf node to a write queue of the storage system.
